(19) United States
(12) Patent Application Publication
(10) Pub. No.: US 2026/0032540 A1
(43) Pub. Date: Jan. 29, 2026

(54) HANDLING PREVIOUS SERVING CELL

(71) Applicant: LG ELECTRONICS INC., Seoul (KR)

(72) Inventors: Siyoung CHOI, Seoul (KR); Sunghoon JUNG, Seoul (KR); Sangwon KIM, Seoul (KR); Hongsuk KIM, Seoul (KR)

(73) Assignee: LG ELECTRONICS INC., Seoul (KR)

(21) Appl. No.: 18/996,876

(22) PCT Filed: Aug. 2, 2023
(86) PCT No.: PCT/KR2023/011283

§ 371 Date: Jan. 17, 2025

Related U.S. Application Data
(60) Provisional application No. 63/395,867, filed on Aug. 8, 2022.

(51) Int. Cl. H04W 36/08; H04W 36/00

(52) U.S. Cl. CPC H04W 36/08; H04W 36/0061

(57) ABSTRACT

A method and apparatus for handling previous serving cell is provided. A wireless device receives a cell configuration for a first cell, and receives a candidate cell configuration for a second cell. The second cell is added to a candidate cell list for mobility. Upon receiving a first mobility command, the wireless device applies the candidate cell configuration for the second cell, and the first cell is added to the candidate cell list for mobility. The wireless device preserves the cell configuration for the first cell, and upon receiving a second mobility command, applies the preserved cell configuration for the first cell.

### CROSS-REFERENCE TO RELATED APPLICATION(S)

This application is the National Stage filing under 35 U.S.C. 371 of International Application No. PCT/KR2023/011283, filed on Aug. 2, 2023, which claims the benefit of U.S. Provisional Application No. 63/395,867, filed on Aug. 8, 2022, the contents of which are all incorporated by reference herein in their entirety.

### TECHNICAL FIELD

The present disclosure relates to handling previous serving cell.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

When a User Equipment (UE) moves from the coverage area of one cell to another cell, at some point, a serving cell change needs to be performed. Currently, serving cell change is triggered by L3 measurements and is done by Radio Resource Control (RRC) signaling-triggered Reconfiguration with Synchronization for change of Primary Cell (PCell) and Primary Secondary Cell (PSCell), as well as release add for SCells when applicable. All cases involve complete L2 (and L1) resets, leading to longer latency, larger overhead and longer interruption time than beam switch mobility.

The goal of L1/L2 mobility enhancements is to enable a serving cell change via L1/L2 signaling, in order to reduce the latency, overhead and interruption time.

### SUMMARY

The present disclosure is to provide a method and apparatus for handling previous serving cell upon performing Lower-layer Triggered Mobility (LTM).

In an aspect, a method performed by a wireless device adapted to operate in a wireless communication system is provided. The method comprises receiving a cell configuration for a first cell, receiving a candidate cell configuration for a second cell, wherein the second cell is added to a candidate cell list for mobility. The method comprises, upon receiving a first mobility command, applying the candidate cell configuration for the second cell, wherein the first cell is added to the candidate cell list for mobility. The method comprises preserving the cell configuration for the first cell, and upon receiving a second mobility command, applying the preserved cell configuration for the first cell.

In another aspect, an apparatus for implementing the above method is provided.

The present disclosure may have various advantageous effects.

For example, the UE can keep the source resources and configurations and can perform TA maintenance and BFD/RLM after successful mobility execution.

For example, the UE can perform RACH-less mobility to the candidate serving cell.

For example, the latency and interruption time caused by UE performing RACH can be reduced.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of UE to which implementations of the present disclosure are applied.

FIGS. 4 and 5 show an example of protocol stacks in a 3GPP based wireless communication system to which implementations of the present disclosure are applied.

FIG. 6 shows a frame structure in a 3GPP based wireless communication system to which implementations of the present disclosure are applied.

FIG. 7 shows a data flow example in the 3GPP NR system to which implementations of the present disclosure are applied.

FIG. 8 shows an example of a method performed by a wireless device to which implementations of the present disclosure are applied.

FIG. 9 shows an example of a method performed by a base station to which implementations of the present disclosure are applied.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in Downlink (DL) and SC-FDMA in Uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

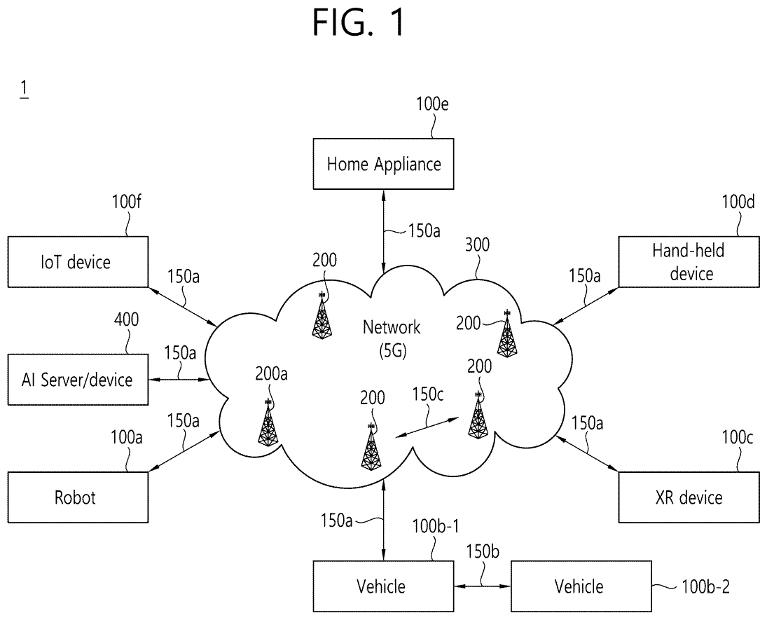

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FRI and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FRI may include an unlicensed band. Unlicensed bands may be used for a variety of purposes, for example for communication for vehicles (e.g., autonomous driving).

TABLE 2

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include NarrowBand IoT (NB-IOT) technology for low-power communication as well as LTE, NR and 6G. For example, NB-IOT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

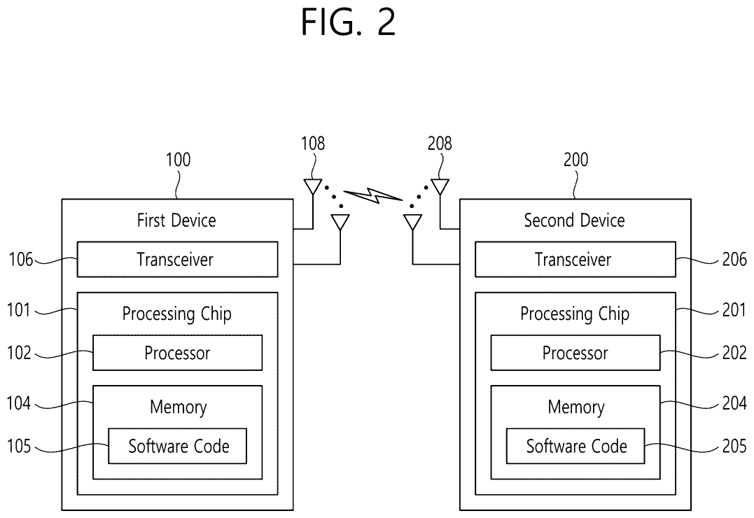

FIG. 2 shows an example of wireless devices to which implementations of the present disclosure are applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

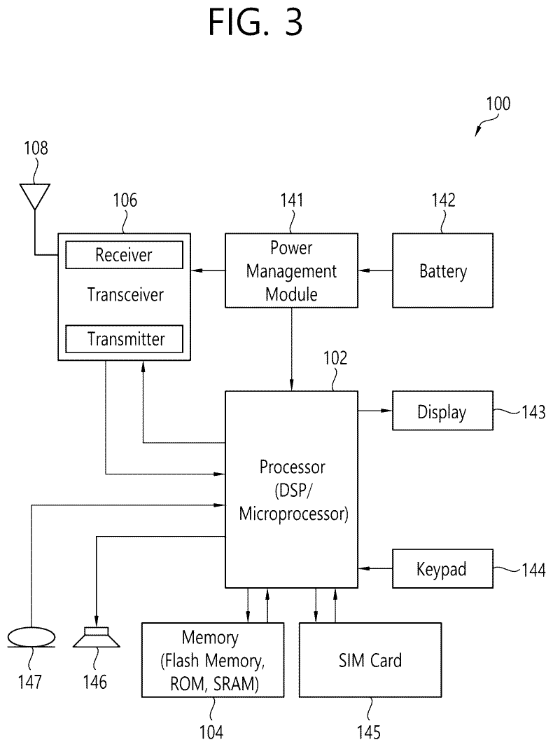

FIG. 3 shows an example of UE to which implementations of the present disclosure are applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

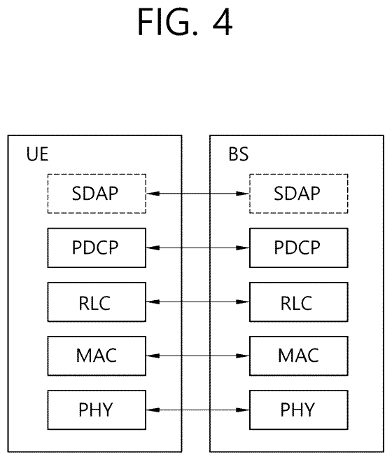

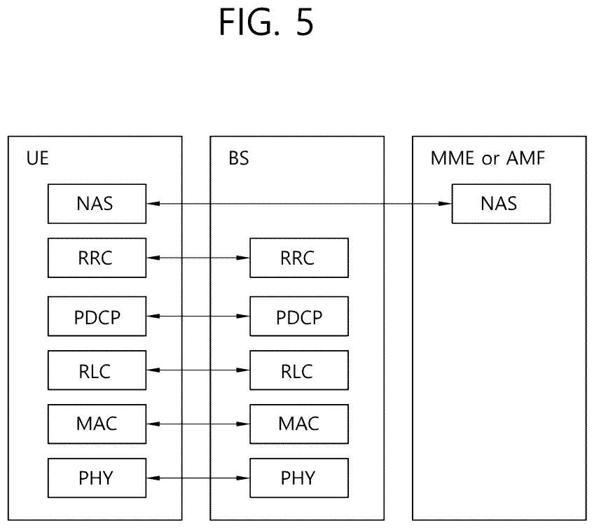

FIGS. 4 and 5 show an example of protocol stacks in a 3GPP based wireless communication system to which implementations of the present disclosure are applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

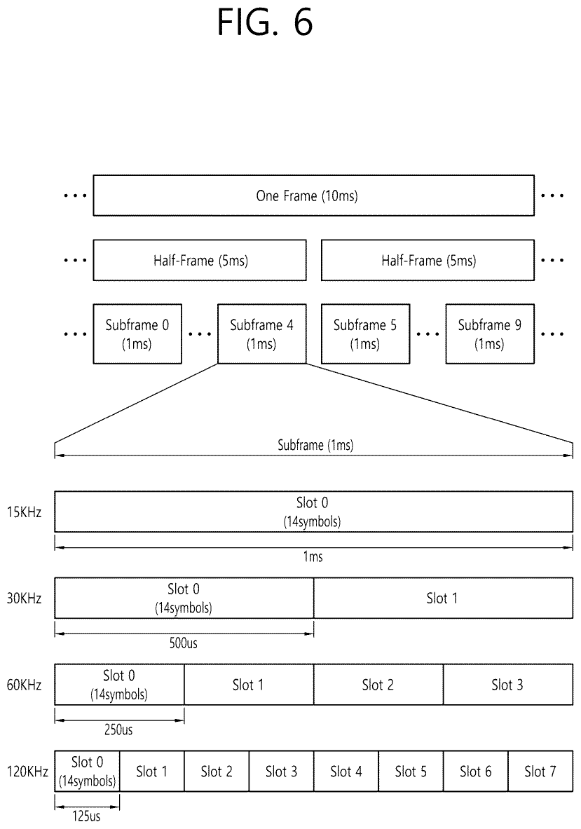

FIG. 6 shows a frame structure in a 3GPP based wireless communication system to which implementations of the present disclosure are applied.

The frame structure shown in FIG. 6 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{u}*15 KHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{start,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0 and upwards in the frequency domain for subcarrier spacing configuration w. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL Component Carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell (SpCell). The configured set of serving cells for a UE therefore always consists of one PCell and one or more SCells. For Dual Connectivity (DC) operation, the term SpCell refers to the PCell of the Master Cell Group (MCG) or the Primary SCell (PSCell) of the Secondary Cell Group (SCG). An SpCell supports Physical Uplink Control Channel (PUCCH) transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

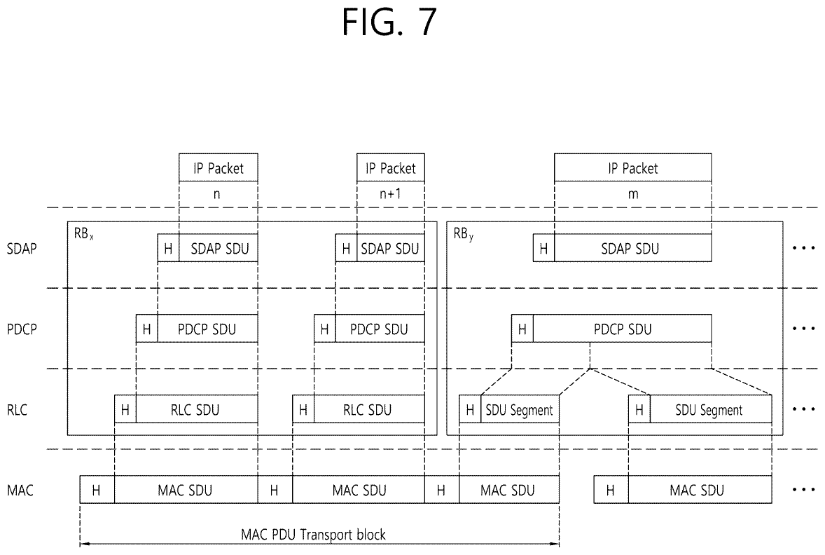

FIG. 7 shows a data flow example in the 3GPP NR system to which implementations of the present disclosure are applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Network controlled mobility applies to UEs in RRC_CONNECTED and is categorized into two types of mobility: cell level mobility and beam level mobility. Beam level mobility includes intra-cell beam level mobility and inter-cell beam level mobility.

Cell level mobility requires explicit RRC signaling to be triggered, i.e., handover. For inter-gNB handover, the signaling procedures consist of at least the following operations.
1. The source gNB initiates handover and issues a HANDOVER REQUEST message over the Xn interface.
2. The target gNB performs admission control and provides the new RRC configuration as part of the HANDOVER REQUEST ACKNOWLEDGE message.
3. The source gNB provides the RRC configuration to the UE by forwarding the RRCReconfiguration message received in the HANDOVER REQUEST ACKNOWLEDGE message. The RRCReconfiguration message includes at least cell identity (ID) and all information required to access the target cell so that the UE can access the target cell without reading system information. For some cases, the information required for contention-based and contention-free random access can be included in the RRCReconfiguration message. The access information to the target cell may include beam specific information, if any.
4. The UE moves the RRC connection to the target gNB and replies with the RRCReconfigurationComplete message.

In case of Dual Active Protocol Stack (DAPS) handover, the UE continues the DL user data reception from the source gNB until releasing the source cell and continues the UL user data transmission to the source gNB until successful random access procedure to the target gNB.

Only source and target PCell are used during DAPS handover. CA, DC, Supplementary UL (SUL), multi-Transmission/Reception Point (TRP), Ethernet Header Compression (EHC), Conditional Handover (CHO), User Data Convergence (UDC), NR sidelink configurations and V2X sidelink configurations are released by the source gNB before the handover command is sent to the UE and are not configured by the target gNB until the DAPS handover has completed (i.e., at earliest in the same message that releases the source PCell).

The handover mechanism triggered by RRC requires the UE at least to reset the MAC entity and re-establish RLC, except for DAPS handover, where upon reception of the handover command, the UE:
Creates a MAC entity for target;
Establishes the RLC entity and an associated DTCH logical channel for target for each DRB configured with DAPS;
For each DRB configured with DAPS, reconfigures the PDCP entity with separate security and ROHC functions for source and target and associates them with the RLC entities configured by source and target respectively;
Retains the rest of the source configurations until release of the source.

RRC managed handovers with and without PDCP entity re-establishment are both supported. For DRBs using RLC AM mode, PDCP can either be re-established together with a security key change or initiate a data recovery procedure without a key change. For DRBs using RLC UM mode, PDCP can either be re-established together with a security key change or remain as it is without a key change. For SRBs, PDCP can either remain as it is, discard its stored PDCP PDUs/SDUs without a key change or be re-established together with a security key change.

Data forwarding, in-sequence delivery and duplication avoidance at handover can be guaranteed when the target gNB uses the same DRB configuration as the source gNB.

Timer based handover failure procedure is supported in NR. RRC connection re-establishment procedure is used for recovering from handover failure except in certain CHO or DAPS handover scenarios:
When DAPS handover fails, the UE falls back to the source cell configuration, resumes the connection with the source cell, and reports DAPS handover failure via the source without triggering RRC connection re-establishment if the source link has not been released.
When initial CHO execution attempt fails or HO fails, the UE performs cell selection, and if the selected cell is a CHO candidate and if network configured the UE to try CHO after handover/CHO failure, then the UE attempts CHO execution once, otherwise re-establishment is performed.

Beam level mobility does not require explicit RRC signaling to be triggered. Beam level mobility can be within a cell, or between cells, the latter is referred to as Inter-Cell Beam Management (ICBM). For ICBM, a UE can receive or transmit UE dedicated channels/signals via a TRP associated with a Physical Cell ID (PCI) different from the PCI of a serving cell, while non-UE-dedicated channels/signals can only be received via a TRP associated with a PCI of the serving cell. The gNB provides via RRC signaling the UE with measurement configuration containing configurations of Synchronization Signal Block (SSB)/Channel State Information (CSI) resources and resource sets, reports and trigger states for triggering channel and interference measurements and reports. In case of ICBM, a measurement configuration includes SSB resources associated with PCIs different from the PCI of a serving cell. Beam Level Mobility is then dealt with at lower layers by means of physical layer and MAC layer control signaling, and RRC is not required to know which beam is being used at a given point in time.

SSB-based beam level mobility is based on the SSB associated to the initial DL BWP and can only be configured for the initial DL BWPs and for DL BWPs containing the SSB associated to the initial DL BWP. For other DL BWPs, Beam Level Mobility can only be performed based on CSI-RS.

CHO is defined as a handover that is executed by the UE when one or more handover execution conditions are met. The UE starts evaluating the execution condition(s) upon receiving the CHO configuration, and stops evaluating the execution condition(s) once a handover is executed.

The following principles apply to CHO:
The CHO configuration contains the configuration of CHO candidate cell(s) generated by the candidate gNB(s) and execution condition(s) generated by the source gNB.
An execution condition may consist of one or two trigger condition(s) (CHO events A3/A5). Only single Reference Signal (RS) type is supported and at most two different trigger quantities (e.g., Reference Signal Received Power (RSRP) and Reference Signal Received Quality (RSRQ), RSRP and Signal-to-Noise plus Interference Ratio (SINR), etc.) can be configured simultaneously for the evaluation of CHO execution condition of a single candidate cell.
Before any CHO execution condition is satisfied, upon reception of HO command (without CHO configuration), the UE executes the HO procedure, regardless of any previously received CHO configuration.
While executing CHO, i.e., from the time when the UE starts synchronization with target cell, the UE does not monitor source cell.

In 3GPP Rel-18, L1/L2 command-based inter-cell mobility may be introduced in order to reduce latency, overhead and interruption time. The L1/L2 command-based inter-cell mobility may be referred to as Lower-Layer Triggered Mobility (LTM) and/or may be shortly referred to as L1/L2 mobility.

For L1/L2 mobility, the network may provide the UE in advance with the configuration of a candidate serving cell. If the UE receives the corresponding mobility command via L1/L2 signaling, the UE may apply the configuration of the candidate serving cell indicated by L1/L2 signaling. In order to shorten latency and interruption time caused by inter-cell mobility from a serving cell to a candidate serving cell, the UE in advance may be configured with a candidate serving cell. For example, the UE in advance may receive RRCReconfiguration including reconfigurationWithSync. Then, the UE may perform the followings for the candidate serving cell:
Timing Advance (TA) maintenance: To acquire TA, the UE may perform random access to the candidate serving cell upon receiving the configuration of candidate serving cell
Radio Link Monitoring (RLM)
Beam Failure Detection (BFD)
Radio Resource Management (RRM) measurement

In the existing inter-cell mobility (e.g., network-controlled mobility and conditional mobility), when the mobility is successfully completed, upon receiving an explicit release from the target node, the UE may release resources and configurations of the source cell and stop DL/UL reception/transmission with the source cell. In addition, the UE may stop maintaining TA for the source cell.

After successful mobility execution, the UE may receive a mobility command indicating handover toward the previous serving cell. Then, the UE should perform random access procedure to the previous serving cell because the UE does not perform TA maintenance and RLM for the previous serving cell. In other words, if another mobility is to be performed to the previous serving cell, the network should re-provide the configurations of the previous serving cell, and the UE should perform random access procedure to the previous serving cell to re-obtain the TA. Based on legacy principle, the previous serving cell may be added as a candidate serving cell after successful mobility execution for preparing successive mobility. However, in this case, the UE should initiate a time-consuming operation to the configured candidate serving cell, such as random access procedure, upon receiving the corresponding configuration. These may result in long latency and interruption time.

If the UE keeps maintaining the TA and the configurations of the previous serving cell, the previous serving cell would be a good candidate serving cell, especially, in the dynamic switch scenario among candidate serving cells. The dynamic switching using candidate serving cells would be useful even when the serving cell quality does not become bad, e.g., in cell-ON/OFF scenario for network energy saving or for load balancing among candidate serving cells. In such scenarios, the switching to the previous serving cell would frequently occur, and it is advantageous for the UE to keep the previous serving cell as a candidate serving cell after successful mobility execution.

Therefore, a method for handling the previous serving cell after inter-cell mobility using the candidate serving cell may be needed. Specifically, a method for keeping the previous serving cell as a new candidate serving cell after L1/L2 mobility based on a candidate cell may be needed.

According to implementations of the present disclosure, upon change of a serving cell, the UE may keep configurations and/or resources of the source cell and may change status of the source cell to a candidate serving cell. That is, after serving cell change (i.e., after successful mobility execution), the UE may include the source cell into a list of candidate serving cells that the UE has maintained for mobility events. As a result, the configuration of the source cell may be transferred into a list of candidate serving cell configurations, i.e., the configuration of the source cell may be kept/preserved even after successful mobility execution.

According to implementations of the present disclosure, the UE may keep configurations and/or resources of the source cell and may change status of the source cell to a candidate serving cell, based on an indication provided by the network. In other words, if the mobility command includes an indication indicating that the source cell is changed to a candidate serving cell after successful mobility execution, the UE may keep configurations and/or resources of the source cell and may change status of the source cell to a candidate serving cell.

According to implementations of the present disclosure, for signaling of the indication, the indication may be included in the mobility command. Alternatively and/or additionally, the indication may be pre-configured as part of a serving cell configuration. That is, the indication may be pre-configured per serving cell. When multiple serving cells are configured, the indication may be provided in each of multiple serving cell configurations. Alternatively and/or additionally, the indication may be pre-configured per a pair of a target cell and a source cell. In this case, the source cell configuration may be preserved only if the mobility results in a change of a serving cell from the source cell to the corresponding target cell. Alternatively and/or additionally, the indication may be provided in conditional mobility configuration.

If the serving cell configuration is preserved after the mobility, the UE may keep operations performed in the previous serving cell also in the candidate serving cell during or after the mobility. For example, the UE may continue performing TA maintenance operations and/or BFD/RLF operations for the candidate serving cell, i.e., the previous serving cell.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

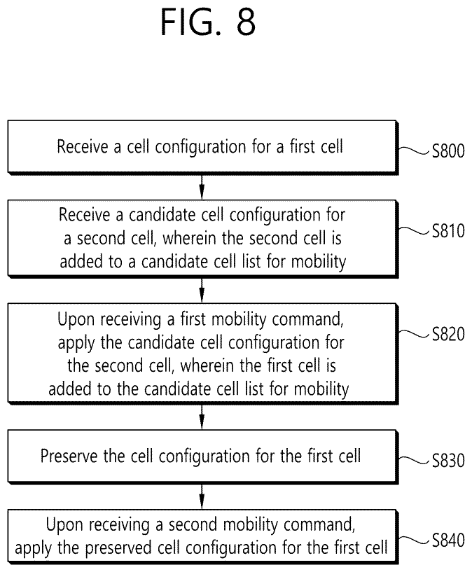

FIG. 8 shows an example of a method performed by a wireless device to which implementations of the present disclosure are applied.

In step S800, the method comprises receiving a cell configuration for a first cell.

In step S810, the method comprises receiving a candidate cell configuration for a second cell. The second cell is added to a candidate cell list for mobility.

In step S820, the method comprises, upon receiving a first mobility command, applying the candidate cell configuration for the second cell. That is, the wireless device executes the mobility towards the second cell. The first cell is added to the candidate cell list for mobility.

In some implementations, the first mobility command may be received via any one of L1 signaling, L2 signaling or L3 signaling.

In some implementations, the mobility may include at least one of a network-controlled serving cell change or UE autonomous serving cell change (e.g., CHO). That is, the first mobility command may be for either network-controlled serving cell change or UE autonomous serving cell change (e.g., CHO).

In some implementations, the first mobility command may include target cell information. If the target cell is one of the preconfigured candidate serving cells, the first mobility command may include an identifier (ID) of candidate serving cell indicated by the first mobility command. Else if the target cell is not one of the preconfigured candidate serving cells, the first mobility command may include a configuration for the target cell, e.g., E.g. RRCReconfiguration including reconfigurationWithSync.

For example, the first mobility command may include the candidate cell configuration for the second cell. That is, the candidate cell configuration for the second cell may be received via the first mobility command. For example, the first mobility command including the candidate cell configuration for the second cell may be RRCReconfiguration including reconfigurationWithSync.

For example, the first mobility command may include an identifier of the second cell based on the first mobility command not including the candidate cell configuration for the second cell. That is, if the second cell is one of the preconfigured candidate serving cells, the candidate cell configuration for the second cell may be preconfigured, and the first mobility command may not include the candidate cell configuration for the second cell but only include an identifier of the second cell.

In some implementations, the first mobility command may include a conditional reconfiguration, e.g., ConditionalReconfiguration.

In some implementations, explicit information informing that the first cell is to be added to the candidate list is included in one of the cell configuration for the first cell or the first mobility command. That is, the cell configuration for the first cell and/or the first mobility command may include an indicator indicating that the source cell is changed to a candidate serving cell. For example, the explicit information may be 1-bit indication in DCI or MAC Control Element (CE). For example, the explicit information may be explicit RRC Information Element (IE). The target cell may be included in a list, where the list may indicate that the source cell is changed to a candidate serving cell. The cell configuration for the first cell may be preserved based on the explicit information.

In some implementations, the explicit information may be configured per a pair of a target cell and a source cell. The source cell may be added to the candidate cell list for mobility based on only applying a candidate cell configuration for the corresponding target cell.

In some implementations, the first mobility command received via any one of L1 signaling or L2 signaling may implicitly inform that the first cell is to be added to the candidate list. That is, the mobility command received via L1/L2 signaling may implicitly indicate that the source cell is changed to a candidate serving cell. The cell configuration for the first cell may be preserved based on the first mobility command received via any one of L1 signaling or L2 signaling.

In some implementations, the first cell may be added to the candidate cell list for mobility upon receiving the candidate cell configuration for the second cell. Or, the first cell may be added to the candidate cell list for mobility upon applying the candidate cell configuration for the second cell.

In some implementations, if the received first mobility command includes ConditionalReconfiguration and if an execution condition is satisfied for the second cell, the wireless device may apply the stored candidate cell configuration (e.g., condRRCReconfig) for the second cell.

In some implementations, if the second cell is one of the preconfigured candidate serving cells, the wireless device may apply the stored candidate cell configuration for the second cell.

In some implementations, if the second cell is not one of the preconfigured candidate serving cells, the wireless device may apply the candidate cell configuration for the second cell which is included in the first mobility command.

In step S830, the method comprises preserving the cell configuration for the first cell.

In some implementations, the wireless device may transmit a first message to the second cell upon applying the candidate cell configuration for the second cell. The first message may be transmitted via L1 signaling, e.g., PUCCH, PUSCH, etc. The first message may be transmitted via L2 signaling, e.g., MAC CE. The first message may be transmitted via L3 signaling, e.g., RRCReconfigurationComplete message.

In some implementations, the wireless device may receive a second message from the second cell in response to the first message. The second message may indicate an acknowledge of the first message transmitted to the second cell. The second message may inform that the mobility to the second cell is successfully executed.

In some implementations, upon preserving the cell configuration for the first cell, the wireless device may perform at least one of i) TA maintenance, ii) BFD, or iii) RLM, for the first cell.

For example, if the first mobility command message is received via any one of L1 signaling or L2 signaling and implicitly inform that the first cell is to be added to the candidate list, the wireless device may keep/preserve the cell configuration for the first cell and resources for the first cell, and may perform at least one of TA maintenance, BFD, RLM.

For example, if the first mobility command message includes explicit information informing that the first cell is to be added to the candidate list (i.e., informing that the source cell is changed to a candidate serving cell), the wireless device may keep/preserve the cell configuration for the first cell and resources for the first cell, and may perform at least one of TA maintenance, BFD, RLM.

In some implementations, else, the wireless device may release the source resources and configurations and stops DL/UL reception/transmission with the source cell.

In step S840, the method comprises, upon receiving a second mobility command, applying the preserved cell configuration for the first cell.

In some implementations, the second mobility command may be received via any one of L1 signaling, L2 signaling or L3 signaling.

In some implementations, the wireless device may be in communication with at least one of a mobile device, a network, and/or autonomous vehicles other than the wireless device.

Furthermore, the method in perspective of the wireless device described above in FIG. 8 may be performed by the first wireless device 100 shown in FIG. 2 and/or the UE 100 shown in FIG. 3.

The wireless device comprises at least one transceiver, at least one processor, and at least one memory operably connectable to the at least one processor and storing instructions that, based on being executed by the at least one processor, perform the method described in FIG. 8.

More specifically, the wireless device receives a cell configuration for a first cell.

The wireless device receives a candidate cell configuration for a second cell. The second cell is added to a candidate cell list for mobility.

Upon receiving a first mobility command, the wireless device applies the candidate cell configuration for the second cell. That is, the wireless device executes the mobility towards the second cell. The first cell is added to the candidate cell list for mobility.

In some implementations, the first mobility command may be received via any one of L1 signaling, L2 signaling or L3 signaling.

In some implementations, the mobility may include at least one of a network-controlled serving cell change or UE autonomous serving cell change (e.g., CHO). That is, the first mobility command may be for either network-controlled serving cell change or UE autonomous serving cell change (e.g., CHO).

In some implementations, the first mobility command may include target cell information. If the target cell is one of the preconfigured candidate serving cells, the first mobility command may include ID of candidate serving cell indicated by the first mobility command. Else if the target cell is not one of the preconfigured candidate serving cells, the first mobility command may include a configuration for the target cell, e.g., E.g. RRCReconfiguration including reconfigurationWithSync.

For example, the first mobility command may include the candidate cell configuration for the second cell. That is, the candidate cell configuration for the second cell may be received via the first mobility command. For example, the first mobility command including the candidate cell configuration for the second cell may be RRCReconfiguration including reconfigurationWithSync.

For example, the first mobility command may include an identifier of the second cell based on the first mobility command not including the candidate cell configuration for the second cell. That is, if the second cell is one of the preconfigured candidate serving cells, the candidate cell configuration for the second cell may be preconfigured, and the first mobility command may not include the candidate cell configuration for the second cell but only include an identifier of the second cell.

In some implementations, the first mobility command may include a conditional reconfiguration, e.g., ConditionalReconfiguration.

In some implementations, explicit information informing that the first cell is to be added to the candidate list is included in one of the cell configuration for the first cell or the first mobility command. That is, the cell configuration for the first cell and/or the first mobility command may include an indicator indicating that the source cell is changed to a candidate serving cell. For example, the explicit information may be 1-bit indication in DCI or MAC CE. For example, the explicit information may be explicit RRC IE. The target cell may be included in a list, where the list may indicate that the source cell is changed to a candidate serving cell. The cell configuration for the first cell may be preserved based on the explicit information.

In some implementations, the explicit information may be configured per a pair of a target cell and a source cell. The source cell may be added to the candidate cell list for mobility based on only applying a candidate cell configuration for the corresponding target cell.

In some implementations, the first mobility command received via any one of L1 signaling or L2 signaling may implicitly inform that the first cell is to be added to the candidate list. That is, the mobility command received via L1/L2 signaling may implicitly indicate that the source cell is changed to a candidate serving cell. The cell configuration for the first cell may be preserved based on the first mobility command received via any one of L1 signaling or L2 signaling.

In some implementations, the first cell may be added to the candidate cell list for mobility upon receiving the candidate cell configuration for the second cell. Or, the first cell may be added to the candidate cell list for mobility upon applying the candidate cell configuration for the second cell.

In some implementations, if the received first mobility command includes ConditionalReconfiguration and if an execution condition is satisfied for the second cell, the wireless device may apply the stored candidate cell configuration (e.g., condRRCReconfig) for the second cell.

In some implementations, if the second cell is one of the preconfigured candidate serving cells, the wireless device may apply the stored candidate cell configuration for the second cell.

In some implementations, if the second cell is not one of the preconfigured candidate serving cells, the wireless device may apply the candidate cell configuration for the second cell which is included in the first mobility command.

The wireless device preserves the cell configuration for the first cell.

In some implementations, the wireless device may transmit a first message to the second cell upon applying the candidate cell configuration for the second cell. The first message may be transmitted via L1 signaling, e.g., PUCCH, PUSCH, etc. The first message may be transmitted via L2 signaling, e.g., MAC CE. The first message may be transmitted via L3 signaling, e.g., RRCReconfigurationComplete message.

In some implementations, the wireless device may receive a second message from the second cell in response to the first message. The second message may indicate an acknowledge of the first message transmitted to the second cell. The second message may inform that the mobility to the second cell is successfully executed.

In some implementations, upon preserving the cell configuration for the first cell, the wireless device may perform at least one of i) TA maintenance, ii) BFD, or iii) RLM, for the first cell.

For example, if the first mobility command message is received via any one of L1 signaling or L2 signaling and implicitly inform that the first cell is to be added to the candidate list, the wireless device may keep/preserve the cell configuration for the first cell and resources for the first cell, and may perform at least one of TA maintenance, BFD, RLM.

For example, if the first mobility command message includes explicit information informing that the first cell is to be added to the candidate list (i.e., informing that the source cell is changed to a candidate serving cell), the wireless device may keep/preserve the cell configuration for the first cell and resources for the first cell, and may perform at least one of TA maintenance, BFD, RLM.

In some implementations, else, the wireless device may release the source resources and configurations and stops DL/UL reception/transmission with the source cell.

Upon receiving a second mobility command, the wireless device applies the preserved cell configuration for the first cell.

In some implementations, the second mobility command may be received via any one of L1 signaling, L2 signaling or L3 signaling.

Furthermore, the method in perspective of the wireless device described above in FIG. 8 may be performed by control of the processor 102 included in the first wireless device 100 shown in FIG. 2 and/or by control of the processor 102 included in the UE 100 shown in FIG. 3.

A processing apparatus adapted to control a wireless device comprises at least one processor, and at least one memory operably connectable to the at least one processor. The at least one processor is adapted to perform the method described in FIG. 8.

Furthermore, the method in perspective of the wireless device described above in FIG. 8 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as Synchronous DRAM (SDRAM), ROM, Non-Volatile RAM (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory Computer-Readable Medium (CRM) stores instructions that, based on being executed by at least one processor, perform the method described in FIG. 8.

In the above description, for example, applying the cell configuration may be performed as follows.

The UE may perform the following actions upon reception of the RRCReconfiguration, or upon execution of the conditional reconfiguration (CHO, Conditional PSCell Addition (CPA) or Conditional PSCell Change (CPC)).
1> if the RRCReconfiguration includes the masterCellGroup:
2> perform the cell group configuration for the received masterCellGroup;
1> if the RRCReconfiguration message includes the conditionalReconfiguration:
2> perform conditional reconfiguration;
For the cell group configuration, the UE may perform the following actions based on a received CellGroupConfig IE:
1 if the CellGroupConfig contains the spCellConfig with reconfigurationWithSync:
2> perform reconfiguration with sync;
The UE may perform the following actions to execute a reconfiguration with sync.
1> if the AS security is not activated, perform the actions upon going to RRC_IDLE with the release cause ‘other’ upon which the procedure ends;

1> stop timer T430 if running;
1> start timer T430 with the timer value set to ntn-UlSyncValidityDuration from the subframe indicated by epochTime, according to the target cell NTN-config;
1> if no DAPS bearer is configured:
2> stop timer T310 for the corresponding SpCell, if running;
1> if this procedure is executed for the MCG:
2> if timer T316 is running;
3> stop timer T316;
3> clear the information included in VarRLF-Report, if any;
2> resume MCG transmission, if suspended.
1> stop timer T312 for the corresponding SpCell, if running;
1> if sl-PathSwitchConfig is included:
2> consider the target L2 U2N Relay UE to be the one indicated by the targetRelayUE-Identity in the slPathSwitchConfig;
2> start timer T420 for the corresponding target L2 U2N Relay UE with the timer value set to T420, as included in the sl-PathSwitchConfig;
2> apply the value of the new UE-Identity as the C-RNTI;
2> indicate to upper layer (to trigger the PC5 unicast link establishment) with the target L2 U2N Relay UE indicated by the targetRelayUE-Identity;
2> apply the default configuration of SL-RLC1 for SRB1;
1> else (sl-PathSwitchConfig is not included):
2> if this procedure is executed for the MCG or if this procedure is executed for an SCG not indicated as deactivated in the E-UTRA or NR RRC message in which the RRCReconfiguration message is embedded:
3> start timer T304 for the corresponding SpCell with the timer value set to t304, as included in the reconfigurationWithSync;
2> if the frequencyInfoDL is included:
3> consider the target SpCell to be one on the SSB frequency indicated by the frequencyInfoDL with a physical cell identity indicated by the physCellId;
2> else:
3> consider the target SpCell to be one on the SSB frequency of the source SpCell with a physical cell identity indicated by the physCellId;
2> start synchronizing to the DL of the target SpCell;
2> apply the specified BCCH configuration for the target SpCell;
2> acquire the MIB of the target SpCell;
2> If any DAPS bearer is configured:
3> create a MAC entity for the target cell group with the same configuration as the MAC entity for the source cell group;
3> for each DAPS bearer:
4> establish an RLC entity or entities for the target cell group, with the same configurations as for the source cell group;
4> establish the logical channel for the target cell group, with the same configurations as for the source cell group;
3> for each SRB:
4> establish an RLC entity for the target cell group, with the same configurations as for the source cell group;
4> establish the logical channel for the target cell group, with the same configurations as for the source cell group;
3> suspend SRBs for the source cell group;
3> apply the value of the new UE-Identity as the C-RNTI in the target cell group;
3> configure lower layers for the target SpCell in accordance with the received spCellConfigCommon;
3> configure lower layers for the target SpCell in accordance with any additional fields, not covered in the previous, if included in the received reconfigurationWithSync.
2> else:
3> reset the MAC entity of this cell group;
3> consider the SCell(s) of this cell group, if configured, that are not included in the SCellToAddModList in the RRCReconfiguration message, to be in deactivated state;
3> apply the value of the new UE-Identity as the C-RNTI for this cell group;
3> configure lower layers in accordance with the received spCellConfigCommon;
3> configure lower layers in accordance with any additional fields, not covered in the previous, if included in the received reconfigurationWithSync.
2> if the UE is acting as L2 U2N Remote UE at the source side:
3> indicate upper layer to trigger PC5 unicast link release.

For CHO, the UE may:
1> for each condReconfigId within the VarConditionalReconfig:
2> if the RRCReconfiguration within condRRCReconfig includes the masterCellGroup including the reconfigurationWithSync:
3> consider the cell which has a physical cell identity matching the value indicated in the ServingCellConfigCommon included in the reconfigurationWithSync within the masterCellGroup in the received condRRCReconfig to be applicable cell;
2> else if the RRCReconfiguration within condRRCReconfig includes the secondaryCellGroup including the reconfigurationWithSync:
3> consider the cell which has a physical cell identity matching the value indicated in the ServingCellConfigCommon included in the reconfigurationWithSync within the secondaryCellGroup within the received condRRCReconfig to be applicable cell;
2> if condExecutionCondSCG is configured:
3> in the remainder of the procedure, consider each measId indicated in the condExecutionCondSCG as a measId in the VarMeasConfig associated with the SCG measConfig;
2> if condExecutionCond is configured:
3> if it is configured via SRB3 or configured within nr-SCG or within nr-SecondaryCellGroupConfig via SRB1:
4> in the remainder of the procedure, consider each measId indicated in the condExecutionCond as a measId in the VarMeasConfig associated with the SCG measConfig;
3> else:
4> in the remainder of the procedure, consider each measId indicated in the condExecutionCond as a measId in the VarMeasConfig associated with the MCG measConfig;
2> for each measId included in the measIdList within VarMeasConfig indicated in the condExecutionCond or condExecutionCondSCG associated to condReconfigId:
3> if the condEventId is associated with condEventT1, and if the entry condition applicable for this event associated with the condReconfigId, i.e. the event corresponding with the condEventId(s) of the corresponding condTriggerConfig within VarConditionalReconfig, is fulfilled for the applicable cell; or
3> if the condEventId is associated with condEventD1, and if the entry conditions applicable for this event associated with the condReconfigId, i.e. the event corresponding with the condEventId(s) of the corresponding condTriggerConfig within VarConditionalReconfig, is fulfilled for the applicable cell during the corresponding timeToTrigger defined for this event within the VarConditionalReconfig; or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigId has been modified; or
3> if the condEventId is associated with condEventT1, and if the leaving condition applicable for this event associated with the condReconfigId, i.e. the event corresponding with the condEventId(s) of the corresponding condTriggerConfig within VarConditionalReconfig, is fulfilled for the applicable cell; or
3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cell during the corresponding timeToTrigger defined for this event within the VarConditionalReconfig; or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;
3> initiate the conditional reconfiguration execution;
The UE may:
1> if more than one triggered cell exists:
2> select one of the triggered cells as the selected cell for conditional reconfiguration execution;
1> else:
2> consider the triggered cell as the selected cell for conditional reconfiguration execution;
1> for the selected cell of conditional reconfiguration execution:
2> apply the stored condRRCReconfig of the selected cell;

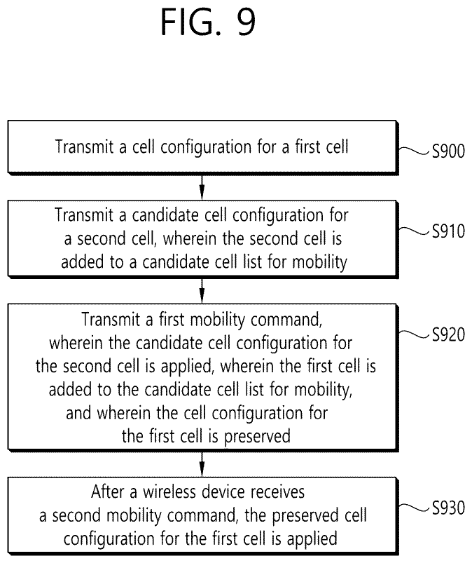

FIG. 9 shows an example of a method performed by a base station to which implementations of the present disclosure are applied.

In step S900, the method comprises transmitting a cell configuration for a first cell.

In step S910, the method comprises transmitting a candidate cell configuration for a second cell. The second cell is added to a candidate cell list for mobility.

In step S920, the method comprises transmitting a first mobility command. The candidate cell configuration for the second cell is applied. The first cell is added to the candidate cell list for mobility. The cell configuration for the first cell is preserved.

In step S930, after a wireless device receives a second mobility command, the preserved cell configuration for the first cell is applied.

Furthermore, the method in perspective of the base station serving a second serving cell described above in FIG. 9 may be performed by the second wireless device 200 shown in FIG. 2.

The base station comprises at least one transceiver, at least one processor, and at least one memory operably connectable to the at least one processor and storing instructions that, based on being executed by the at least one processor, perform the method described in FIG. 9.

More specifically, the base station transmits a cell configuration for a first cell.

The base station transmits a candidate cell configuration for a second cell. The second cell is added to a candidate cell list for mobility.

The base station transmits a first mobility command. The candidate cell configuration for the second cell is applied. The first cell is added to the candidate cell list for mobility. The cell configuration for the first cell is preserved.

After a wireless device receives a second mobility command, the preserved cell configuration for the first cell is applied.

Various embodiments of the present disclosure are described in below.

### 1. Network-Controlled Serving Cell Change

(1) Case 1: The UE receives the mobility command for a serving cell change, where the mobility command is transmitted via L1/L2 signaling (i.e., L1/L2 mobility or LTM).

The UE may consider the candidate serving cell indicated by the mobility command as the target cell and consequently regards the configuration for candidate serving cell as that for target cell.

The UE may apply the configuration of target cell. The UE may send a first message to the target cell, where the first message may be transmitted via any one of L1 signaling (e.g., PUCCH, PUSCH, etc.), L2 signaling (e.g., MAC CE) or L3 signaling (e.g., RRCReconfigurationComplete message). The UE may receive a second message (i.e., ACK) from the target cell, where the second message implies successful mobility execution.

The UE may consider the previous serving cell (i.e., the source cell in the mobility) as a new candidate serving cell. The UE may keep/preserve configurations/resources of the previous serving cell, and may perform TA maintenance, RLM/BFD, and RRM measurement for the new candidate serving cell.
(2) Case 2: The UE receives the mobility command for a serving cell change, where the mobility command is transmitted via L3 signaling and includes an indicator that indicates the source cell is changed to a candidate serving cell after successful mobility execution.

The UE may apply the configuration of target cell. The UE may perform random access procedure to the target cell. The UE may send a first message to the target cell, where the first message may be transmitted via L3 signaling (e.g., RRCReconfigurationComplete message). The UE may receive a second message (i.e., ACK) from the target cell, where the second message implies successful mobility execution.

The UE may consider the previous serving cell (i.e., the source cell in the mobility) as a new candidate serving cell. The UE may keep/preserve configurations/resources of the previous serving cell, and may perform TA maintenance, RLM/BFD, and RRM measurement for the new candidate serving cell.
(3) Case 3 (Legacy operation): The UE receives the mobility command for a serving cell change, where the mobility command is transmitted via L3 signaling and does not include an indicator that indicates the source cell is changed to a candidate serving cell after successful mobility execution.

The UE may apply the configuration of target cell. The UE may perform random access procedure to the target cell. The UE may send a first message to the target cell, where the first message may be transmitted via L3 signaling (e.g., RRCReconfigurationComplete message). The UE may receive a second message (i.e., ACK) from the target cell, where the second message implies successful mobility execution.

The UE may release the resources and configurations for the previous serving cell (i.e., the source cell) and stops DL/UL reception/transmission with the source cell. The UE may receive the configuration of a new candidate serving cell, where the new candidate serving cell is the same as the previous serving cell. The UE may perform random access procedure to the new candidate serving cell. The UE may perform TA maintenance, RLM/BFD, and RRM measurement for the new candidate serving cell.

### 2. UE Autonomous Serving Cell Change (e.g., Conditional Mobility)

(1) Case 1: The configuration for conditional mobility includes an indicator that indicates the source cell is changed to a candidate serving cell after successful mobility execution.

If the execution condition of conditional mobility is satisfied for target cell, the UE may apply the configuration of target cell. The UE may perform random access procedure to the target cell. The UE may send a first message to the target cell, where the first message may be transmitted via L3 signaling (e.g., RRCReconfigurationComplete message). The UE may receive a second message (i.e., ACK) from the target cell, where the second message implies successful mobility execution.

The UE may consider the previous serving cell (i.e., the source cell in the mobility) as a new candidate serving cell. The UE may keep/preserve configurations/resources of the previous serving cell, and may perform TA maintenance, RLM/BFD, and RRM measurement for the new candidate serving cell.
(2) Case 2 (Legacy operation): The configuration for conditional mobility does not include an indicator that indicates the source cell is changed to a candidate serving cell after successful mobility execution.

If the execution condition of conditional mobility is satisfied for target cell, the UE may apply the configuration of target cell. The UE may perform random access procedure to the target cell. The UE may send a first message to the target cell, where the first message may be transmitted via L3 signaling (e.g., RRCReconfigurationComplete message). The UE may receive a second message (i.e., ACK) from the target cell, where the second message implies successful mobility execution.

The UE may release the resources and configurations for the previous serving cell (i.e., the source cell) and stops DL/UL reception/transmission with the source cell. The UE may receive the configuration of a new candidate serving cell, where the new candidate serving cell is the same as the previous serving cell. The UE may perform random access procedure to the new candidate serving cell. The UE may perform TA maintenance, RLM/BFD, and RRM measurement for the new candidate serving cell.

### 3. Network-Controlled Cell Group Change

(1) Case 1: The UE receives the mobility command for a cell group change, where the mobility command includes an indicator that indicates the source cell group is changed to a candidate cell group after successful mobility execution.

The UE may apply the configuration of target cell group. The UE may send a first message to the PCell of target cell group, where the first message may be transmitted via L3 signaling (e.g., RRCReconfigurationComplete message). The UE may receive a second message (i.e., ACK) from a cell included in the target cell group, where the second message implies successful mobility execution.

The UE may consider the previous serving cell group (i.e., the source cell group) as a new candidate serving cell group. The UE may keep/preserve configurations/resources of the previous serving cell group, and may perform TA maintenance, RLM/BFD, and RRM measurement for the PCell of the new candidate serving cell group.
(2) Case 2 (Legacy operation): The UE receives the mobility command for a cell group change, where the mobility command does not include the indicator that indicates the source cell group is changed to a candidate cell group after successful mobility execution.

The UE may apply the configuration of target cell group. The UE may send a first message to the PCell of target cell group, where the first message may be transmitted via L3 signaling (e.g., RRCReconfigurationComplete message). The UE may receive a second message (i.e., ACK) from a cell included in the target cell group, where the second message implies successful mobility execution.

The UE may release the resources and configurations for the previous serving cell group (i.e., the source cell group) and stops DL/UL reception/transmission with the source cell group. The UE may receive the configuration of a new candidate serving cell group, where the new candidate serving cell group is the same as the previous serving cell group. The UE may perform random access procedure to the PCell of the new candidate serving cell group. The UE may perform TA maintenance, RLM/BFD, and RRM measurement for the PCell of the new candidate serving cell group.

### 4. UE Autonomous Cell Group Change (e.g., Conditional Mobility)

(1) Case 1: The configuration for conditional mobility includes an indicator that indicates the source cell group is changed to a candidate cell group after successful mobility execution.

If the execution condition of conditional mobility is satisfied for target cell group, the UE may apply the configuration of target cell group. The UE may send a first message to the PCell of target cell group, where the first message may be transmitted via L3 signaling (e.g., RRCReconfigurationComplete message). The UE may receive a second message (i.e., ACK) from a cell included in the target cell group, where the second message implies successful mobility execution.

The UE may consider the previous serving cell group (i.e., the source cell group) as a new candidate serving cell group. The UE may keep/preserve configurations/resources of the previous serving cell group, and may perform TA maintenance, RLM/BFD, and RRM measurement for the PCell of the new candidate serving cell group.
(2) Case 2 (Legacy operation): The configuration for conditional mobility does not include an indicator that indicates the source cell group is changed to a candidate serving cell after successful mobility execution.

If the execution condition of conditional mobility is satisfied for target cell group, the UE may apply the configuration of target cell group. The UE may send a first message to the PCell of target cell group, where the first message may be transmitted via L3 signaling (e.g., RRCReconfigurationComplete message). The UE may receive a second message (i.e., ACK) from a cell included in the target cell group, where the second message implies successful mobility execution.

The UE may release the resources and configurations for the previous serving cell group (i.e., the source cell group) and stops DL/UL reception/transmission with the source cell group. The UE may receive the configuration of a new candidate serving cell group, where the new candidate serving cell group is the same as the previous serving cell group. The UE may perform random access procedure to the PCell of the new candidate serving cell group. The UE may perform TA maintenance, RLM/BFD, and RRM measurement for the PCell of the new candidate serving cell group.

The present disclosure may have various advantageous effects.

For example, the UE can keep the source resources and configurations and can perform TA maintenance and BFD/RLM after successful mobility execution.

For example, the UE can perform RACH-less mobility to the candidate serving cell.

For example, the latency and interruption time caused by UE performing RACH can be reduced.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving a cell configuration for a first cell;
receiving a candidate cell configuration for a second cell,
wherein the second cell is added to a candidate cell list for mobility;
upon receiving a first mobility command, applying the candidate cell configuration for the second cell,
wherein the first cell is added to the candidate cell list for mobility;
preserving the cell configuration for the first cell; and
upon receiving a second mobility command, applying the preserved cell configuration for the first cell.

2. The method of claim 1, wherein the first mobility command and/or the second mobility command is received via any one of L1 signaling, L2 signaling or L3 signaling.

3. The method of claim 1, wherein the mobility includes at least one of a network-controlled serving cell change or User Equipment (UE) autonomous serving cell change.

4. The method of claim 1, wherein the first mobility command includes the candidate cell configuration for the second cell.

5. The method of claim 1, wherein the first mobility command includes an identifier of the second cell based on the first mobility command not including the candidate cell configuration for the second cell.

6. The method of claim 1, wherein the first mobility command includes a conditional reconfiguration.

7. The method of claim 1, wherein explicit information informing that the first cell is to be added to the candidate list is included in one of the cell configuration for the first cell or the first mobility command.

8. The method of claim 7, wherein the cell configuration for the first cell is preserved based on the explicit information.

9. The method of claim 7, wherein the explicit information is configured per a pair of a target cell and a source cell.

10. The method of claim 9, wherein the source cell is added to the candidate cell list for mobility based on only applying a candidate cell configuration for the target cell.

11. The method of claim 1, wherein the first mobility command received via any one of L1 signaling or L2 signaling implicitly informs that the first cell is to be added to the candidate list.

12. (canceled)

13. The method of claim 1, wherein the first cell is added to the candidate cell list for mobility upon receiving the candidate cell configuration for the second cell.

14. The method of claim 1, wherein the first cell is added to the candidate cell list for mobility upon applying the candidate cell configuration for the second cell.

15. The method of claim 1, wherein a first message is transmitted to the second cell upon applying the candidate cell configuration for the second cell.

16. (canceled)

17. The method of claim 1, wherein a second message is received from the second cell in response to the first message.

18. The method of claim 17, wherein the second message informs that the mobility to the second cell is successfully executed.

19. The method of claim 1, wherein at least one of i) a Timing Advance (TA) maintenance, ii) a Beam Failure Detection (BFD), or iii) a Radio Link Monitoring (RLM) is performed for the first cell, upon preserving the cell configuration for the first cell.

20. The method of claim 1, wherein the wireless device is in communication with at least one of a mobile device, a network, and/or autonomous vehicles other than the wireless device.

21. A wireless device comprising:
at least one transceiver:
at least one processor; and
at least one memory operably connectable to the at least one processor and storing instructions that, based on being executed by the at least one processor, perform the method operations comprising:
receiving, via the at least one transceiver, a cell configuration for a first cell:
receiving, via the at least one transceiver, a candidate cell configuration for a second cell,
wherein the second cell is added to a candidate cell list for mobility;
upon receiving a first mobility command, applying the candidate cell configuration for the second cell,
wherein the first cell is added to the candidate cell list for mobility:
preserving the cell configuration for the first cell; and
upon receiving a second mobility command, applying the preserved cell configuration for the first cell.

22-24. (canceled)

25. A base station serving a second serving cell comprising:
at least one transceiver;
at least one processor; and
at least one memory operably connectable to the at least one processor and storing instructions that, based on being executed by the at least one processor, perform operations comprising:
transmitting, via the at least one transceiver, a cell configuration for a first cell;
transmitting, via the at least one transceiver, a candidate cell configuration for a second cell,
wherein the second cell is added to a candidate cell list for mobility; and
transmitting, via the at least one transceiver, a first mobility command,
wherein the candidate cell configuration for the second cell is applied,
wherein the first cell is added to the candidate cell list for mobility,
wherein the cell configuration for the first cell is preserved, and
wherein, after a wireless device receives a second mobility command, the preserved cell configuration for the first cell is applied.
